(19) United States
(12) Patent Application Publication
(10) Pub. No.: US 2014/0298051 A1
(43) Pub. Date: Oct. 2, 2014

(54) FEATURE MANAGEMENT SYSTEM AND METHOD OF MANAGING ACCESS TO APPLICATION PROGRAMMING INTERFACE FUNCTIONALITY

(71) Applicant: NVIDIA CORPORATION, Santa Clara, CA (US)

(72) Inventors: David Wyatt, Santa Clara, CA (US); Daniel Nolan, Austin, TX (US)

(73) Assignee: Nvidia Corporation, Santa Clara, CA (US)

(21) Appl. No.: 13/852,076

(22) Filed: Mar. 28, 2013

(51) Int. Cl. G06F 13/10; G06F 9/54

(52) U.S. Cl. CPC G06F 13/102; G06F 9/541
USPC 713/320; 719/321

(57) ABSTRACT

A feature management system and method of managing access to API functionality. One embodiment of the feature management system includes: (1) a driver configured to carry out functions, including a restricted function, in response to calls thereto, (2) a memory configured to store a management action associated with the restricted function and (3) a feature manager operable to recognize the call to the restricted function and to retrieve the management action from the memory and direct the driver to carry out the management action in addition to the restricted function.

### TECHNICAL FIELD

This application is directed, in general, to computer graphics processing and, more specifically, to managing access to various features of an application programming interface (API).

### BACKGROUND

Many modern computing products remain in service for many years and require occasional software updates. These updates may be firmware or driver updates for computer hardware, or revisions for an application. Software updates typically resolve problems with the existing system or include additional capability with respect to the latest baseline. In some cases, updates are procured to enhance the capability of a lesser, more restricted version. Manufacturers often market multiple capability levels of the same base product to target different consumer groups. For instance, an application can be marketed as a student version, a small business version and a professional version. Each provides distinct capability, distinct features and at distinct price points. A student version, or similarly low-capability level version, typically has a certain amount of disabled capability that becomes available at higher levels.

Coincident with the product lifecycle and multi-level capability is the development cycle. Initial capability available in a computing product is often supplemented and sometimes replaced by newer, more powerful features. Manufacturers accordingly manage the capability of a product and, more specifically, manage access to features that are present. Assuming a working initial system, to add capability and to make it readily available to all users is the simplest approach. Manufacturers generally prefer to deprecate older, obsolete and error-ridden features in favor of newer, more robust features. However, to maintain backward compatibility, deprecated features are phased out over a period of time before they are disabled entirely. This improves the overall performance and maintainability of the product, in addition to the maintainability of peripheral systems. Manufacturers use this mechanism to great effect to restrict the features of a system to only those appropriate for a given point in time and at a given price point and capability level.

### SUMMARY

One aspect provides a feature management system, including: (1) a driver configured to carry out functions, including a restricted function, in response to calls thereto, (2) a memory configured to store a management action associated with the restricted function and (3) a feature manager operable to recognize the call to the restricted function and to retrieve the management action from the memory and direct the driver to carry out the management action in addition to the restricted function.

Another aspect provides a method of managing access to API functionality, including: (1) receiving a call to a restricted function, (2) determining a management action and (3) carrying out both the management action and the restricted function.

Yet another aspect provides a graphics processing subsystem, including: (1) a display driver capable of a set of functions, (2) an application programming interface (API) configured to provide access to the set of functions, (3) a memory configured to store a list identifying a subset of the functions that are restricted functions and a respective management action for each of the restricted functions and (4) a feature manager operable to: (4a) recognize a call to one of the restricted functions through the API, (4b) determine the respective management action based on the list and (4c) direct the display driver to carry out the one of the restricted functions and the respective management action.

### BRIEF DESCRIPTION

Reference is now made to the following descriptions taken in conjunction with the accompanying drawings, in which:

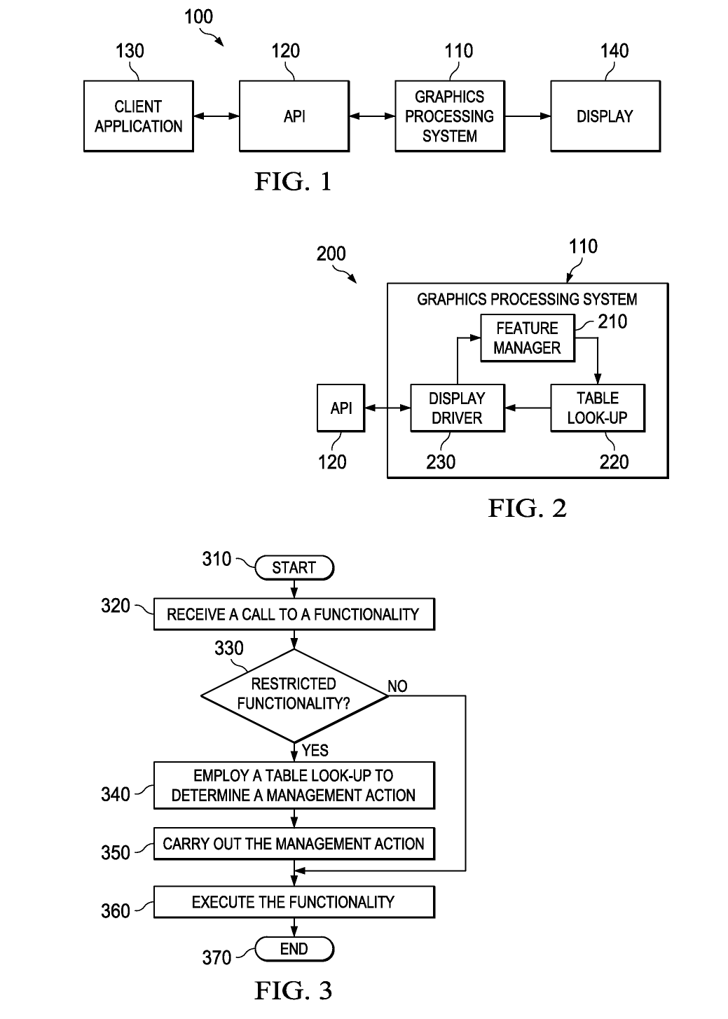

FIG. 1 is a block diagram of a computing system;

FIG. 2 is a block diagram of one embodiment of a feature management system; and

FIG. 3 is a flow diagram of one embodiment of a method for managing access to API functionality.

### DETAILED DESCRIPTION

It is realized herein that an important stage of a product's lifecycle is omitted from conventional feature management schemes. In the computer graphics industry, features often go through an evaluation period before being included in the baseline version of the product. Whether the evaluation is for the benefit of the end user or the developer, it is often helpful for newer or more advanced features to be available for use on a limited, or restricted, basis. Data can be collected from these uses to aid in making design and procurement decisions in the future.

Capability in graphics processing systems improves at a rapid pace. It is realized herein that new capability can be made available to certain privileged users during an evaluation period. In software this is frequently referred to as “beta testing.” It is realized herein that for graphics processing, rather than disabling all restricted features, distinctions can be made between disabled features and features available for evaluation. This distinction allows certain users to incorporate evaluation features into graphics applications without being disrupted by the usual errors. It is further realized herein that rather than halt execution of the product, evaluation features should executed normally, as otherwise licensed features.

It is realized herein that the evaluation features can be accompanied by subtle, internal actions by the graphics processing system that are undetectable by, or “invisible” to, graphics applications. Certain features may trigger the display of a copyright notice, while others may trigger the display of a warning message or other visual cue. These accompanying actions provide the user notice that a restricted feature is being used, without exposing the graphics processing system to systematic probing by client graphics applications. It is also realized herein that under certain circumstances the usage of restricted features can be tracked to prevent misuse and to gauge the demand for new features.

It is further realized herein that various techniques may be employed to authenticate client graphics applications so that the features available in a graphics processing system are correctly distinguished from one another. Accordingly, various embodiments of the feature management system and method authenticate client graphics applications by employ a registry key, authenticating the application with a certificate authority or employing known or later-developed secret or public key encryption techniques.

Before describing various embodiments of the feature management system and method of managing access to API functionality introduced herein, a computing system within which a feature management system or method of managing access to API functionality may be embodied or carried out will be described.

FIG. 1 is a block diagram of a computing system 100 within which a feature management system or method of managing access to API functionality may be embodied or carried out. Computing system 100 includes a graphics processing system 110, an API 120, a client application 130 and a display 140. Client application 130 is a typical piece of software that executes on a conventional processor or central processing unit (CPU). Client application 130 consists of some amount of on-screen computing and some amount of off-screen computing, or “background” computing. On-screen computing ultimately produces graphics that require rendering and display. Graphics range from simple windows and banners to complex lighting and shading effects.

Graphics processing system 110 is a specialized system for rendering graphics and driving a display, such as display 140. Graphics processing system 110 includes functionalities, or “features,” that can be employed by client application 130 to create, render and ultimately display graphics on display 140. The functionalities provided by graphics processing system 110 include various subsets of functionalities that are disabled, licensed or available for evaluation. Disabled functionalities are restricted from being called by client application 130. A call to disabled functionalities would result in an error, or an “exception.” Licensed functionalities are typical functionalities that are freely callable by client application and operate accordingly as long as the call is syntactically correct. Functionalities available for evaluation are also freely callable; however, their use triggers a side effect indicating their status as available for evaluation. Side effects, or “management actions,” are generally visual cues and are not detectable by client application 130. Disabled functionalities and those available for evaluation are considered “restricted.” A distinction between them is that disabled functionalities are not carried out by graphics processing system 110, while those available for evaluation are, along with the additional management action.

Client application 130 implements on-screen computing by employing the various functionalities provided by graphics processing system 110. Access to the functionalities is had according to API 120. API 120 is generally an interface layer that limits exposure of the many details of graphics processing system 110 to just that necessary to parameterize data in client application 130 and make the necessary calls to functions for creating, rendering and displaying graphics.

Having described a computing system within which the feature management system or method of managing access to API functionality may be embodied or carried out, various embodiments of the system and method will be described.

FIG. 2 is a block diagram of one embodiment of a feature management system 200. Feature management system 200 includes graphics processing system 110 and API 120 of FIG. 1. Graphics processing system 110 includes a feature manager 210, table look-up 220 and display driver 230. The various features of graphics processing system 110 are implemented in and carried out by display driver 230. Calls to the features originate in an application and are received by display driver 230 through API 120. Upon receipt of a call, a determination is made by feature manager 210 as to whether the call is directed to a feature that is disabled, licensed or available for evaluation. Calls to disabled features are not carried out, while calls to features licensed and available for evaluation are.

When feature manager 210 recognizes a call to a restricted feature, which is either a disabled feature or one available for evaluation, feature manager 210 refers to table look-up 220 to determine an appropriate management action. Alternate embodiments of feature management system 200 could employ a variety of alternatives to implement table look-up 220, including: lists, linked lists, associative arrays, search trees and hash tables. Accordingly, the appropriate management action for a disabled feature would be to prevent display driver 230 from carrying out the associated function. The appropriate management action for an evaluation feature may be a variety of things, including displaying a watermark or copyright notice while the evaluation feature is active and displaying a warning. Further management actions include tracking options such as counting calls to or identifying users of restricted functions. Management actions are carried out by graphics processing system 110 and are undetectable through API 120. Management actions that are visual in nature would be carried out by display driver 230. Tracking management actions could be carried out by either feature manager 210 or display driver 230.

FIG. 3 is a flow diagram of one embodiment of a method for managing access to API functionality. The method begins in a start step 310. In a step 320, a call to a function is received. A determination is made, in a step 330, as to whether the function called at step 320 is restricted. If the function is not restricted, it is executed in a step 360. Otherwise, the function is restricted, and the method proceeds to a look-up step 340. In the step 340, a table look-up is employed to determine an appropriate management action to take. The appropriate management action is carried out in a step 350, and the restricted function is carried out in the step 360.

In certain embodiments, the restricted function may be disabled. In those embodiments the appropriate management action would be to omit the execution in the step 360. The method then ends in a step 370.

Those skilled in the art to which this application relates will appreciate that other and further additions, deletions, substitutions and modifications may be made to the described embodiments.

What is claimed is:

1. A feature management system, comprising:
a driver configured to carry out functions, including a restricted function, in response to calls thereto;
a memory configured to store a management action associated with said restricted function; and
a feature manager operable to recognize said call to said restricted function and to retrieve said management action from said memory and direct said driver to carry out said management action in addition to said restricted function.

2. The feature management system recited in claim 1 wherein said driver is a display driver.

3. The feature management system recited in claim 2 wherein said management action is to display a visual cue undetectable by a client application originating said call but displayable by said display driver.

4. The feature management system recited in claim 1 wherein said memory is further configured to store multiple management actions respectively associated with multiple restricted functions and retrievable by said feature manager via a table look-up.

5. The feature management system recited in claim 1 wherein said feature manager is further operable to recognize a call to an unrestricted function and to direct no management action with respect to said unrestricted function.

6. The feature management system recited in claim 1 further comprising a processor operable to execute a client application that makes said call through an application programming interface (API).

7. The feature management system recited in claim 1 further comprising a feature tracker configured to count a number of times said restricted feature is called.

8. A method of managing access to application programming interface (API) functionality, comprising:
receiving a call to a restricted function;
determining a management action; and
carrying out both said management action and said restricted functionality.

9. The method recited in claim 8 further comprising a client application generating said call.

10. The method recited in claim 9 wherein said management action is a triggering of a cue observable by a user and undetectable by said client application.

11. The method recited in claim 8 further comprising tracking usage of said restricted function.

12. The method recited in claim 8 further comprising verifying said call is directed to said restricted function.

13. The method recited in claim 8 wherein said determining includes employing a table look-up to identify said management action.

14. The method recited in claim 8 wherein said restricted function is in a state selected from the group consisting of:
disabled;
licensed; and
evaluation.

15. A graphics processing subsystem, comprising:
a display driver capable of a set of functions;
an application programming interface (API) configured to provide access to said set of functions;
a memory configured to store a list identifying a subset of said functions that are restricted functions and a respective management action for each of said restricted functions; and
a feature manager operable to:
recognize a call to one of said restricted functions through said API,
determine said respective management action based on said list, and
direct said display driver to carry out said one of said restricted functions and said respective management action.

16. The graphics processing subsystem recited in claim 15 wherein said respective management action is to display a visual cue.

17. The graphics processing subsystem recited in claim 15 wherein said feature manager is further operable to prevent said display driver from carrying out said one of said restricted functions if said one of said restricted functions is disabled.

18. The graphics processing subsystem recited in claim 15 wherein said feature manager is configured to track calls to said one of said restricted functions.

19. The graphics processing subsystem recited in claim 15 further comprising a client application configured to employ said API to gain access to said set of functionality and to generate said call to said one of said restricted functions.

20. The graphics processing subsystem recited in claim 19 wherein said respective management action is undetectable by said client application.
